(19) United States
(12) Patent Application Publication
(10) Pub. No.: US 2026/0071708 A1
(43) Pub. Date: Mar. 12, 2026

(54) COUPLING FOR LIQUIFIED GASES

(71) Applicant: MANN TEKNIK AB, MARIESTAD (SE)

(72) Inventors: Gerhard KOPPLIN, MARIESTAD (SE); Guanyíng LI, Töreboda (SE)

(73) Assignee: MANN TEKNIK AB, MARIESTAD (SE)

(21) Appl. No.: 19/107,182

(22) PCT Filed: Sep. 5, 2023
(86) PCT No.: PCT/SE2023/050875

§ 371 Date: Feb. 27, 2025

(30) Foreign Application Priority Data
Sep. 5, 2022 (SE) 2251025-9

(51) Int. Cl. F16L 37/44; F16L 59/065

(52) U.S. Cl. CPC F16L 37/44; F16L 59/065

(57) ABSTRACT

A coupling (1) for liquefied gas comprises a male part (10) and second part (40) to be coupled to each other by insertion of the first part (10) into the second part (40). An internal liquefied gas conduit to be fluidly connected for transfer of liquefied gas through the coupling (1). A valve (42) is movable between a first position, in which transfer of liquefied gas through the coupling is blocked, and a second position, in which transfer of liquefied gas through the coupling is allowed. With the parts (10, 40) interconnected, the coupling has a first operating state in which no liquefied gas is transferred though the coupling and a second operating state in which liquefied gas is allowed to flow through the coupling, By providing least one sensor (14, 16, 20) adapted to sense states of the coupling to enable control the fuelling process, an automated process is provided.

### TECHNICAL FIELD

The present invention relates generally to couplings and more specifically to a coupling for transferring cryogenic medias with vacuum insulated pipe or hose lines, together with a poppet, which are movable in the axial direction to the coupling plug with pneumatic or hydraulic supply, wherein the pneumatic or hydraulic supply is/are outside of the vacuum insulated pipe or hose lines with any gas or liquid media, thus conduit open the other side of the conduit in the coupling plug, e.g. single or multi poppet, for transferring cryogenic media.

### BACKGROUND ART

Under the zero emissions target or a CO2-neutral future for the global environmental issue, clean energy such as hydrogen and natural gas play more role to the increasing demand. One example is that the clean liquified gases, in particularly hydrogen, which are produced by solar, wind and other clean energy, are of more need for transportation in liquified phase due to lower volume. On the other hand, liquified gases as a fuel for long-haul transportation, such as trucks, ships, airplane, and rocket, are considered due to the high energy & high-density fuel.

In cryogenic applications variations in temperature could quickly become dangerous, especially if liquified gases reach boiling temperatures causing them to expand rapidly. One example is Liquid hydrogen (LH2) that at atmospheric pressure needs to be maintained below −253° C. for it to stay in a liquid state. LH2 at boiling point can expend around 800 times in volume to hydrogen gas (GH2) at ambient temperature which creating dangerous pressure. It is commonly known such cryogenic media can only be realized by appropriate insulation measures such as vacuum insulated pipe or hose line for transferring or for fuelling.

In particularly, for fuelling cryogenic liquified gas, especially LH2, couplings are one critical and vulnerable component where thermal bridges and dead spaces containing for example air could provide dangerous variations. For example, in atmospheric pressure LNG is condensed to liquid at temperatures below approximately −160° C. , oxygen for liquid oxygen nitrogen for liquid nitrogen, LN2, approximately −195° C. , and liquid hydrogen, LH2, at temperatures below approximately −253° C. . To keep it is critical that no foreign particles, including condensed liquid or solid oxygen, nitrogen, are introduced into the storage, for example a fuel cell, when transferring the liquified gases as a fuel. Potential leakage of H2 at dead spaces with condensed liquid oxygen may lead to an explosion as well.

Liquified gases are used for different purposes but independent of the purpose efficiency and safety are important factors. To provide one out of many examples, liquified gases may be used as fuel and need to be transferred from a fuelling station to for example a truck. Although the transfer as such is well known in the art there are drawbacks in the art reducing the efficiency. For example, an open connector without poppet. This type of coupling will need to purge the complete conduit with inert gas for testing leakage first and then empty Insulation is a way to avoid the heat loss during transferring the cryogenic media, which means also less ‘cold’ will be transferred to outside of the operation area. Effective insulation means the systems don't have to work as hard to maintain the operating temperature of the unit, thereby reducing energy consumption. One known vacuum insulation is with multiple insulation materials, such as aluminium foil rolling within the vacuum chamber.

### SUMMARY OF INVENTION

An object of the present invention is to provide a coupling for liquified gases to connect and disconnect hoses quickly without additional tools and without spillage and where reliability and safety are of prime concern.

According to a first aspect of the invention, a coupling for liquefied gas comprises a first male part and second female part to be coupled to each other by insertion of the first part into the second part (40), wherein the first part and the second part each comprises an internal liquefied gas conduit to be fluidly connected for transfer of liquefied gas through the coupling, a valve movable between a first position, in which transfer of liquefied gas through the coupling is blocked, and a second position, in which transfer of liquefied gas through the coupling is allowed, wherein, with the first and second parts interconnected, the coupling has a first operating state in which no liquefied gas is transferred though the coupling and a second operating state in which liquefied gas is allowed to flow through the coupling, the coupling being characterized by at least one sensor adapted to sense a state of the coupling to enable control the fuelling process.

In a preferred embodiment, the state of the coupling comprises if the first and second parts are interconnected.

In a preferred embodiment, the state of the coupling comprises if the first and second parts are locked to each other.

In a preferred embodiment, the state of the coupling comprises the position of the valves.

In a preferred embodiment, the sensor is any of the following: an inductive sensor, a proximity sensor, and a magnetic sensor.

In a preferred embodiment, an insulation, preferably a vacuum insulation, is provided.

In a preferred embodiment, the sensor is arranged outside the insulation.

According to a second aspect of the invention, a nozzle for a coupling according to the invention is provided, the nozzle comprising a first male part connectable to a second female part of the coupling, the first and second pars to be coupled to each other by insertion of the first part into the second part, the first part comprising an internal liquefied gas conduit to be fluidly connected for transfer of liquefied gas through the coupling, wherein, with the first and second parts interconnected, the coupling has a first operating state in which no liquefied gas is transferred though the coupling and a second operating state in which liquefied gas is allowed to flow through the coupling, the nozzle being characterized by at least one sensor provided in the first male part adapted to sense states of the coupling to enable control the fuelling process.

### BRIEF DESCRIPTION OF DRAWINGS

The invention is now described, by way of example, with reference to the accompanying drawings, in which:

FIG. 1 is a sectional view of the coupling of FIG. 1 in a connected position, with no flow therethrough,

FIG. 2 is a sectional view of the coupling of FIG. 1 after connection and locking of the parts of the coupling when purging may start, and

FIG. 3 is a sectional view of the coupling of FIG. 1 after connection and with full flow.

### DESCRIPTION OF EMBODIMENTS

In the following, a detailed description of the different embodiments of the solution is disclosed under reference to the accompanying drawings. All examples herein should be seen as part of the general description and are therefore possible to combine in any way of general terms. Individual features of the various embodiments and aspects may be combined or exchanged unless such combination or exchange is clearly contradictory to the overall function of the device or method.

In this description, the term coupling will denote two halves of connecting units with internal valves, containing a female part in the form of a receptacle, also referred to as tank unit or adapter, and a male part in the form of a nozzle, also referred to as hose unit or coupler. The receptacle is mostly vacuum installed on a transport unit like tank truck, rail car or receiving vessel, while the nozzle is mostly vacuum installed on the supply unit like flexible hose from a fuelling station, loading arm from a storage tank, supply tanker, or bunker vessel.

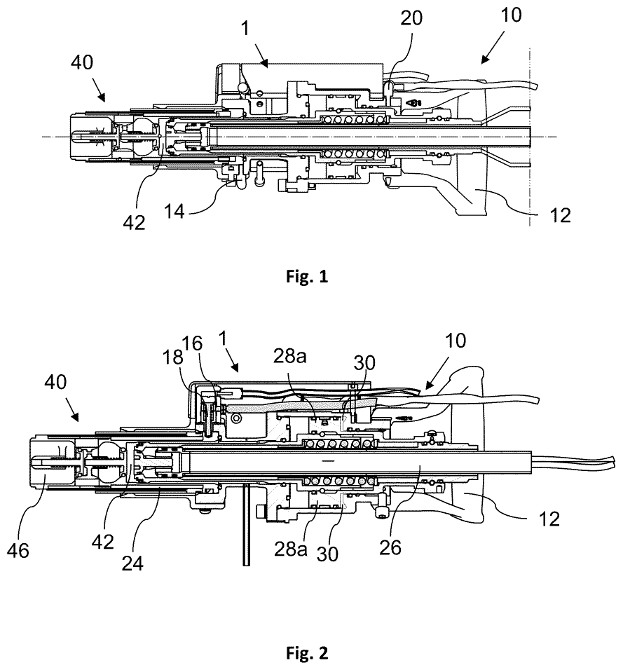

Turning now to FIG. 1, there is shown a coupling, generally designated 1, comprising a first male part in the form of a nozzle 10 and second female part in the form of a receptacle 40 to be coupled to each other by insertion of the nozzle 10 into the receptacle 40. The interconnection between the nozzle 10 and the receptacle 40 is achieved by first inserting the nozzle 10 into the receptacle 40 and then rotating the nozzle 10 around a centre axis thereof by turning handles 12 attached to the nozzle 10. Since the receptacle 40 is fixed against rotation by means of its attachment to the receiving vessel, there will be a mutual rotation between the nozzle 10 and the receptacle 40.

In order to sense the position of the nozzle 10 relatively to the receptacle 40, an interconnection sensor 14 is provided. in the nozzle 10. In this preferred embodiment, the interconnection sensor 14 is provided in or attached to the nozzles 10 engaging in the receptacle 40. The locking device and grooves together form a bayonet joint, as is known in the art. The interconnection sensor 14 may be an inductive sensor, but other options are also possible, such as proximity sensors or magnetic sensors.

In the interconnected position shown in FIG. 1, the nozzle 10 and the receptacle 40 are not locked to each other. In other words, an operator can disengage the nozzle 10 from the receptacle 40 by reversing the interconnection procedure. For a safe operation, a locking sensor 16 is provided which senses whether a locking mechanism 18 has been activated or not. This locking mechanism ensures that the nozzle 10 cannot be disengaged from the receptacle 40. However, in another embodiment the locking mechanism is normally closed, i.e. the nozzle 10 and receptacle 40 are locked to each other as default.

A valve sensor 20 is provided to detect the position of a valve arrangement 42 provided in the receptacle and movable between a first position, in which transfer of liquefied gas through the coupling 1 is blocked, and a second position, in which transfer of liquefied gas through the coupling is allowed. In the embodiment shown in the figures, the valve arrangement 42 comprises poppet valves arranged subsequently after each other in the flow path. For safety reasons, it is imperative that the flow of liquified gas does not start before the nozzle 10 and the receptacle 40 have been locked to each other.

In FIG. 2, the coupling is shown with the nozzle 10 and the receptacle 40 being locked to each other by means of the locking mechanism 18. This means that the operation of transferring liquified gas can be initiated. This operation starts with a so-called purging operation, in which the chamber between the nozzle 10 and the receptacle 40 is flushed with a suitable gas, such as H₂, to ensure that no oxygen remains therein. In connection with this, the valve sensor 20 gives a positive signal for purging position, wherein a cold seal is not engaged with the receptacle 40. Only when the space 24 between the nozzle 10 and the receptacle 40 has been flushed, liquified gas in the gas conduit 26 of the nozzle 10 is allowed to start flowing into the receptacle 40.

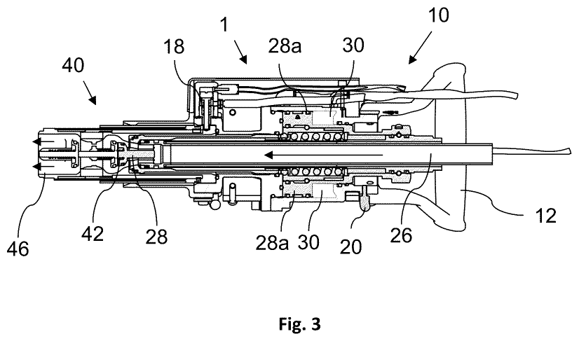

In FIG. 3, the coupling 1 is shown when liquefied gas flows through the gas conduit 26 of the nozzle 10 and the gas conduit 46 of the receptacle 40. As can be seen in this figure, the valve 42 has been pushed from the position in which the valve piston has left its engagement with the valve seat, thus allowing the flow into the gas conduit 46 of the receptacle 40. This displacement of the valve 42 of the receptacle is affected by the displacement of a displacement piston 28 provided in the nozzle 10.

The displacement of the piston 28 is achieved by means of increasing the pressure in a displacement chamber 30 arranged outside of the gas conduit 26 of the nozzle 10, and preferably outside of the insulation, in this case the vacuum insulation. In other words, the pneumatic or hydraulic supply is outside of the vacuum insulated pipe or hose lines with any gas or liquid media. In a preferred embodiment, the pressure of a gas in the displacement chamber 30 is raised to 15-20 Bar in order to achieve the displacement. The gas in the displacement chamber 30 exerts a pressure on a shoulder 28a in rigid mechanical connection with the displacement piston 28, displacing the shoulder 28a and thereby the displacement piston 28 to the left in the figure. The fact that the driving force is completely external of the gas conduit 26 prevents the risk of the liquid gas mixing with other gas is eliminated. Instead of a pneumatic solution with gas in the displacement chamber 30, a hydraulic solution is also possible.

Turning back to the sensors 14, 16, 20, the provision of these enables a completely automated gas flow process once an operator has connected the nozzle 10 to the receptacle 40. This automated process essentially comprises the following steps:
manually interconnecting the nozzle 10 and the receptacle 40 so that the nozzle 10 and the receptacle 40 are in an interconnected state,
detecting the interconnected state,
automatically locking the nozzle 10 to the receptacle 40,
optionally, detecting the valve position,
automatically purging the space 24 between the nozzle 10 and the receptacle 40,
automatically displacing the valve 42 from a first position, in which transfer of liquefied gas through the coupling 1 is blocked, to a second position, in which transfer of liquefied gas through the coupling 1 is allowed.

When the flow of liquefied gas is to be terminated, the process is reversed. In one embodiment of the reversed operation, a spring pushes the valve into a closed position after the pressure is released in the chamber 30. In this embodiment the cold seal remains in a sealing position, thus enabling safe purging of gas trapped in the coupling. Pressure is then applied to the opposite side of the chamber 30 to disengage the cold seal.

Preferred embodiments of a coupling according to the invention and a method of operating such a coupling have been described. It will be appreciated that these embodiments can be modified within the scope of the appended claims without departing from the inventive idea. Thus, a coupling with a dual-valve solution has been shown in the figures. It will be appreciated that the present invention is also applicable to other kinds of valves, such as single-valve solutions.

1-8. (canceled)

9. A coupling for liquefied gas comprising a first part and second part to be coupled to each other by insertion of the first part into the second part, wherein the first part and the second part each comprises an internal liquefied gas conduit to be fluidly connected for transfer of liquefied gas through the coupling,
a valve movable between a first position, in which transfer of liquefied gas through the coupling is blocked, and a second position, in which transfer of liquefied gas through the coupling is allowed,
wherein, with the first and second parts interconnected, the coupling has a first operating state in which no liquefied gas is transferred though the coupling and a second operating state in which liquefied gas is allowed to flow through the coupling,
wherein
at least one sensor adapted to sense a state of the coupling to enable control the fueling process.

10. The coupling according to claim 9, wherein the state of the coupling comprises if the first and second parts are interconnected.

11. The coupling according to claim 9, wherein the state of the coupling comprises if the first and second parts are locked to each other.

12. The coupling according to claim 9, wherein the state of the coupling comprises the position of the valves.

13. The coupling according to claim 9, wherein the sensor is any of the following:
inductive sensor, proximity sensor and magnetic sensor.

14. The coupling according to claim 9, comprising an insulation, preferably a vacuum insulation.

15. The coupling according to claim 14, wherein the sensor is arranged outside the insulation.

16. A nozzle for a coupling according to claim 9, comprising
a first part connectable to a second part of the coupling, the first and second parts to be coupled to each other by insertion of the first part into the second part,
the first part comprising an internal liquefied gas conduit to be fluidly connected for transfer of liquefied gas through the coupling,
wherein, with the first and second parts interconnected, the coupling has a first operating state in which no liquefied gas is transferred though the coupling and a second operating state in which liquefied gas is allowed to flow through the coupling,
wherein
at least one sensor provided in the first part adapted to sense states of the coupling to enable control the fueling process.
